(19) United States
(12) Patent Application Publication
(10) Pub. No.: US 2020/0173366 A1
(43) Pub. Date: Jun. 4, 2020

(54) LIQUID FUEL LEAK DETECTION SYSTEM AND RELATED METHOD

(71) Applicant: General Electric Company, Schenectady, NY (US)

(72) Inventors: Venkateswara Rao Akana, Bangalore (IN); Jeevan Prakash Ammanna, Bangalore (IN); Balaji Narayanan, Bangalore (IN)

(21) Appl. No.: 16/205,434

(22) Filed: Nov. 30, 2018

(51) Int. Cl. F02C 7/22; F02C 3/14

(52) U.S. Cl. CPC F02C 7/222; F02C 3/14; F05D 2220/32; F05D 2270/80; F05D 2260/608; F05D 2270/42; F05D 2260/80

(57) ABSTRACT

A liquid fuel leak detection system for a gas turbine enclosure including a liquid fuel module is disclosed. The system includes a tube probe array positioned adjacent a floor of the gas turbine enclosure under the liquid fuel module, the tube probe array including at least one tube having at least one opening; and a first hazardous gas sensor panel in communication with the tube probe array, the hazardous gas sensor panel detecting a first accumulation level of turbine liquid fuel vapors in the gas turbine enclosure from the liquid fuel module based on input from the tube probe array, and creating an alarm in response to the detected first accumulation level exceeding a first predetermined amount. A pipe array under a fuel delivery system for detecting fuel leaks thereunder may also be provided.

### BACKGROUND OF THE INVENTION

The disclosure relates generally to gas turbine systems, and more particularly, to systems for detecting liquid fuel leaks in a gas turbine enclosure including a liquid fuel module therein.

Conventional gas turbine systems include a compressor, a combustor, and a turbine. In a conventional gas turbine system, compressed air is provided from the compressor to the combustor. The air entering the combustor is mixed with fuel and combusted. Hot gases of combustion flow from the combustor to the turbine to drive the gas turbine system and generate power. Gas turbines are generally housed in enclosures, which include various features for protecting and maintaining the systems. A typical enclosure includes a roof or top wall fastened to four sidewalls about the periphery of the roof. The roof and sidewalls thus form a generally hollow, rectangular enclosure.

Fuel leaks within the gas turbine enclosure require special consideration because of safety concerns. For example, where gas fuel is used, heavier gas fuels, such as propane, butane, etc., may accumulate on the floor of the gas turbine enclosure. Where liquid fuel is used, leaks can also create heavy volatile gases that may accumulate on the floor of the gas turbine enclosure.

The gas turbine includes many pipes and connections for delivering fuel to the gas turbine, resulting in potential leak points within the enclosure. Leakage detection systems for the pipes and connections area can take a variety of forms. Some existing systems include a sensor or plural sensors in an air exhaust duct to detect fuel molecules in the air exhaust. Another approach places a pipe array near the enclosure floor to detect heavier gas fuels near the combustor inside the gas turbine enclosure. The pipe array siphons or scavenges environmental samples for delivery to leakage sensors. This approach employs a suction device, like a fan, to siphon samples. In any event, where a leakage is detected by the sensors, the gas turbine control system may alarm or trip the machine shut down or activate a ventilation system, depending on the level of fuel gas leakage.

New gas turbine system arrangements include a modular gas turbine enclosure coupled with a liquid fuel module positioned with the gas turbine enclosure rather than an external, stand-alone liquid fuel module. A conventional liquid fuel leak detection and ventilation system with a pipe array located underneath the combustor of the gas turbine system only will not be able to sample the liquid fuel vapors from the liquid fuel module. Accordingly, the conventional arrangement makes it difficult to detect leaks from the liquid fuel module.

### BRIEF DESCRIPTION OF THE INVENTION

A first aspect of the disclosure provides a fuel leak detection system for a gas turbine enclosure for a gas turbine system, the gas turbine enclosure including a liquid fuel module therein, the fuel leak detection system comprising: a liquid fuel module leak detection system including: a sensor array positioned adjacent a floor of the gas turbine enclosure under the liquid fuel module, the sensor array including at least one hazardous gas sensor for detecting a first accumulation level of turbine liquid fuel vapors in the gas turbine enclosure from the liquid fuel module, and creating an alarm in response to the at least one hazardous gas sensor detecting the first accumulation level exceeding a first predetermined amount; a fuel leak detection and ventilation system including: a pipe array positioned adjacent the floor of the gas turbine enclosure and under a fuel delivery system for a combustor of the gas turbine system, the pipe array including at least one pipe having at least one opening therein; a ventilation system including a fan and air flow outlet and an air flow inlet, wherein the fan directs an air flow sweep through the air flow inlet along the floor of the gas turbine enclosure; and a first hazardous gas sensor panel in communication with the pipe array and the ventilation system, the first hazardous gas sensor panel detecting a second accumulation level of turbine fuel vapors in the gas turbine enclosure based on input from the pipe array, and activating the ventilation system in response to the detected second accumulation level exceeding a second predetermined amount.

A second aspect of the disclosure provides a liquid fuel module leak detection system for a gas turbine enclosure including a liquid fuel module therein, the liquid fuel module leak detection system comprising: a tube probe array positioned adjacent a floor of the gas turbine enclosure under the liquid fuel module, the tube probe array including at least one tube having at least one opening; and a first hazardous gas sensor panel in communication with the tube probe array, the first hazardous gas sensor panel detecting a first accumulation level of turbine liquid fuel vapors in the gas turbine enclosure from the liquid fuel module based on input from the tube probe array, and creating an alarm in response to the detected first accumulation level exceeding a first predetermined amount.

A third aspect of the disclosure provides a fuel leak detection system for a gas turbine enclosure including a gas turbine system and a liquid fuel module therein, the fuel leak detection system comprising: a pipe array positioned adjacent a floor of the gas turbine enclosure and under a combustor fuel delivery system for a combustor of the gas turbine system, the pipe array including at least one pipe having at least one opening therein; a ventilation system including a fan and an air flow outlet and an air flow inlet, wherein the fan directs an air flow sweep through the air flow inlet along the floor of the gas turbine enclosure; a tube probe array positioned adjacent the floor of the gas turbine enclosure under the liquid fuel module, the tube probe array including at least one tube having at least one opening; and a hazardous gas sensor panel in communication with the pipe array and the tube probe array and the ventilation system, the hazardous gas sensor panel detecting a first accumulation level of liquid fuel vapors in the gas turbine enclosure and under the liquid fuel module based on input from the tube probe array and a second accumulation level of turbine fuel vapors in the gas turbine enclosure based on input from the pipe array, and creating an alarm according to at least one of the detected accumulation levels exceeding a respective predetermined level.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a plan view of a gas turbine enclosure including a conventional fuel leak detection and ventilation system.

FIG. 2 is a plan view of a gas turbine enclosure incorporating a liquid fuel detection system according to embodiments of the disclosure.

FIG. 3 shows an enlarged plan view of a liquid fuel module including a liquid fuel detection system according to embodiments of the disclosure.

FIG. 4 shows a plan view of an illustrative tube probe array positionable under a liquid fuel module within the gas turbine enclosure.

FIG. 5 is a plan view of a gas turbine enclosure incorporating a liquid fuel detection system according to another embodiment of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant machine components within a gas turbine enclosure. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part. In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the ventilating fluid through the gas turbine enclosure or, for example, the flow of air through tubing. The term “downstream” corresponds to the direction of flow of the fluid, and the term “upstream” refers to the direction opposite to the flow. Where an element or layer is referred to as being “on,” “engaged to,” “disengaged from,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

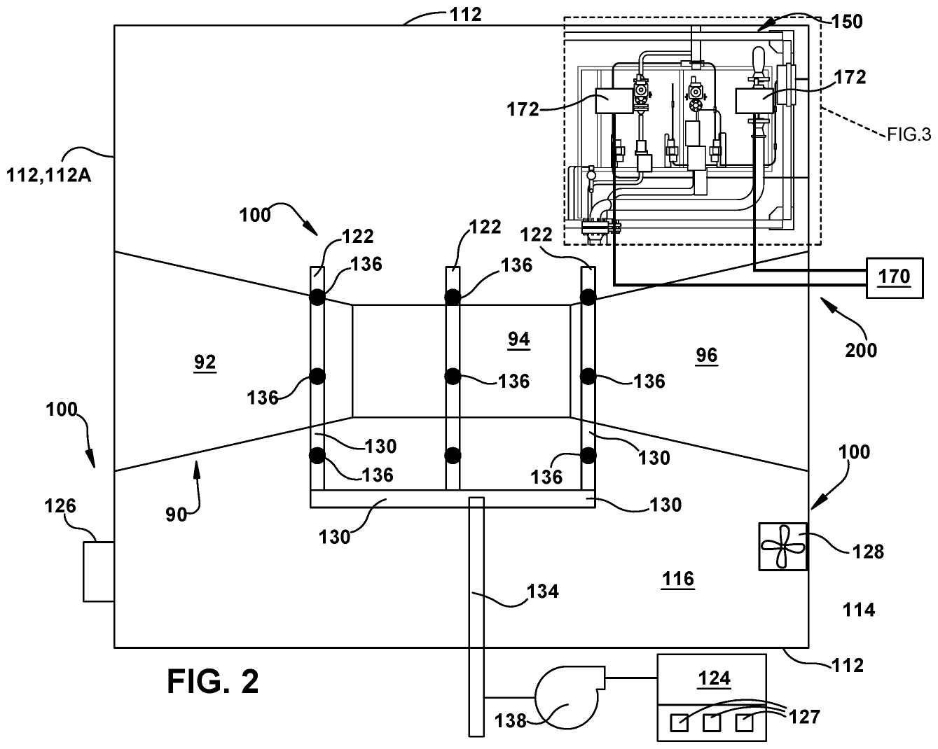

With reference to the drawings, embodiments of the disclosure include a liquid fuel leak detection system 200 (FIGS. 2-5) that may be used alone or with a conventional turbine fuel leak detection and ventilation system 100.

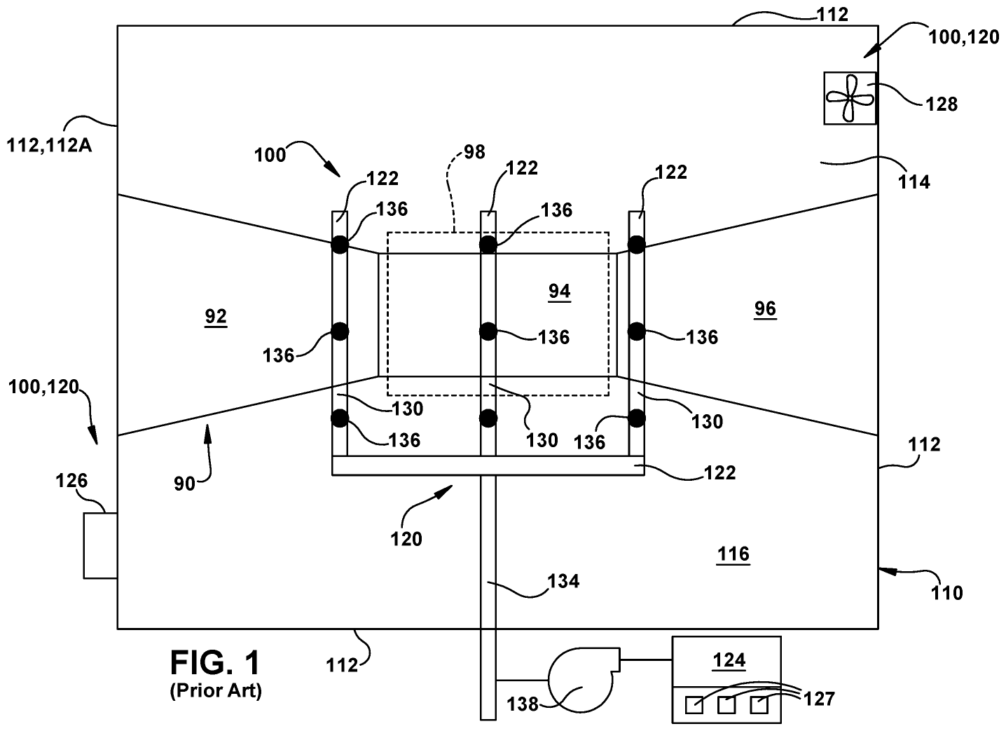

FIG. 1 shows a plan view of a gas turbine system 90 disposed in a gas turbine enclosure 110, and including a turbine fuel leak detection and ventilation system 100. FIG. 1 is a schematic diagram for an illustrative simple-cycle, single-shaft heavy duty gas turbine system 90. Gas turbine system 90 may be considered as comprising a multi-stage axial flow compressor 92 having a rotating shaft (not shown). Air enters the inlet of compressor 92 and is compressed by the axial flow compressor and then is discharged to a combustor 94 where ‘turbine fuel’, such as a gas like natural gas, a liquid fuel or a combination thereof, is burned to provide high energy combustion gases which drive a turbine 96. In turbine 96, the energy of the hot gases is converted into work, some of which may be used to drive compressor 92 through the rotating shaft, with the remainder available for useful work to drive a load such as a generator (not shown). As understood in the art, an extensive combustor fuel delivery system 98 feeds fuel to combustor 94, e.g., natural gas and/or liquid gas. The present disclosure is not limited to any one particular gas turbine system and may be implanted in connection with other engines.

A gas turbine enclosure 110 encloses gas turbine system 90. Gas turbine enclosure 110 includes sidewalls 112, a top wall 114 (shown transparent), and a floor 116. Gas turbine system 90 is disposed within gas turbine enclosure 110. A turbine fuel leak detection and ventilation system 100 may include a sampling pipe array 122 and a hazardous gas sensor panel 124. Hazardous gas sensor panel 124 may include one or more hazardous gas sensors 127 capable of detection accumulation levels of turbine fuel vapors. Any suitable hazardous gas sensor 127 may be used. Sensor panel 124 may include any number of sensors 127.

Conventional turbine fuel leak detection and ventilation system 100 may also include a ventilation system 120 that includes a fan, an airflow inlet 126, and an airflow outlet 128, e.g., in top wall 114. In any event, when activated, the fan directs an airflow sweep through airflow inlet 126 along floor 116 of gas turbine enclosure 110. In FIG. 1, fan/airflow outlet 128 are combined as a single unit, but these may be separately provided. It is preferable for the fan to be located at the outlet duct. However, the fan may be positioned at a number of locations.

With continued reference to FIG. 1, airflow inlet 126 may be positioned in a wall 112A of gas turbine enclosure 110 adjacent floor 116 of gas turbine enclosure 110. Airflow inlet 126 is configured to direct air flow along floor 116 of gas turbine enclosure 110. As shown in FIG. 1, fan/airflow outlet 128 may be positioned in top wall 114 of gas turbine enclosure 110. As an example, the fan may have 283 to 566 cubic meters per minute (1-2 kcfm), powered by an AC motor that consumes 20 to 100 kiloWatts (kW). The fan may create a negative pressure (suction) inside gas turbine enclosure 110 in the range of −284 to −1493 Pascal (1 to 6 inches of water column).

Pipe array 122 is configured to be positioned within gas turbine enclosure 110 adjacent or supported on floor 116 of gas turbine enclosure 110. For example, pipe array 122 can be positioned under various portions of combustion system 94 and/or combustor fuel delivery system 98. As shown in the perspective view of FIG. 1, pipe array 122 includes one or a plurality of pipes 130 connected in parallel to a return pipe 134. Each of pipes 130 includes one or several openings 136. Pipes 130 may include rigid material pipes, e.g., of steel, that are threaded together and held in place by mounts (not shown). Pipes 130 may have an outer diameter of, for example, 2.5 centimeters (cm) to 10 cm. A suction device 138 is coupled with pipe array 122 and draws a vacuum on pipe array 122. Suction device 138 is sized to draw about 1 to 10 cubic feet per minute (CFM) air form the enclosure into the pipe array.

When suction device 138 is activated, pipe array 122 siphons an environmental sample/air from gas turbine enclosure 110. The siphoned air is delivered via return pipe 134 to hazardous gas sensor panel 124. Hazardous gas sensor panel 124 detects an accumulation level of turbine fuel gas in gas turbine enclosure 110 based on input from pipe array 122. In response to sensor panel 124 detecting that the accumulation level exceeds a predetermined amount, the sensor panel 124 creates an alarm, or activates ventilation system 120. In one embodiment, if sensor panel 124 detects a certain hazardous gas concentration level, for example, 5% of LEL, then the system will alarm, while if it reaches a higher level, for example 10% of LEL concentration, then the control system will activate ventilation system 120 to remove the gas. A variety of alternative activation schemes may also be employed, e.g., just an alarm regardless of accumulation level, always at least some ventilation, etc. In any event, a user is made aware of a turbine fuel leak.

Referring to FIG. 2, a plan view of a liquid fuel leak detection system 200 in a gas turbine enclosure 110 according to embodiments of the disclosure is shown. Liquid fuel leak detection system 200 can be used with turbine fuel leak detection and ventilation system 100, described relative to FIG. 1, or can be used alone. As noted, new gas turbine system arrangements position a liquid fuel module 150 with gas turbine system 90 (rather than as an external stand-alone unit). That is, liquid fuel module 150 is in gas turbine enclosure 110 with gas turbine system 90. Liquid fuel module 150 may include any now known or later developed system for portioning liquid fuel for combustor 94 of gas turbine system 90 or other systems requiring fuel. As illustrated, liquid fuel module 150 may include various pipes and valves configured to portion liquid fuel. The positioning of the various pipes and valves of liquid fuel module 150 on floor 116 makes it very difficult to route pipes 130 of pipe array 122 to liquid fuel module 150, which hinders detection of any liquid fuel leaks therefrom.

As shown in FIG. 2, liquid fuel leak detection system 200 according to an embodiment of the disclosures includes a sensor array 168 positioned adjacent floor 116 of gas turbine enclosure 110 under liquid fuel module 150. Sensor array 168 may include one or more hazardous gas sensors 172 positioned adjacent floor 116 of liquid fuel module 150 where detection is required. Each sensor 172 may be a separate unit or may be part of a hazardous gas sensor panel 170 that includes a number of sensors. In either case, each sensor 172 will detect an accumulation level of turbine liquid fuel vapors in gas turbine enclosure 110 from liquid fuel module 150. Each sensor 172 may create an alarm, perhaps with hazardous gas sensor panel 170, in response to the detected first accumulation level of liquid fuel vapors exceeding a first predetermined amount. If one or more sensors 172 detect a certain hazardous vapor concentration level, for example, 5% of LEL, then the system will alarm. Alternatively, where system 200 is used with system 100, if it reaches a higher level, for example 10% of LEL concentration, then the system(s) may activate ventilation system 120 to remove the gas. A variety of alternative activation schemes may also be employed, e.g., just an alarm regardless of accumulation level, always at least some ventilation where paired with ventilation system 120, etc. In any event, a user is made aware of a liquid fuel leak in liquid fuel module 150, even though it is positioned within gas turbine system 90.

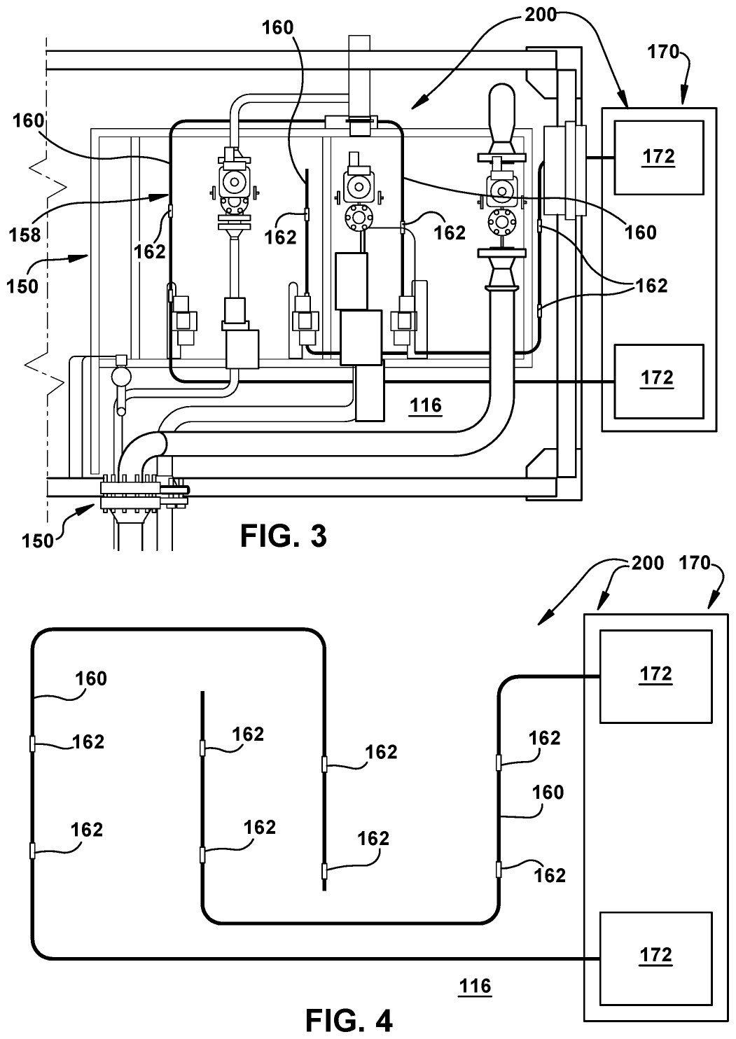

Referring to FIG. 3-4, a liquid fuel leak detection system 200 according to another embodiment of the disclosure is shown. Liquid fuel leak detection system 200 can be used with conventional turbine fuel leak detection and ventilation system 100, described relative to FIGS. 1, or can be used alone. As noted, new gas turbine system arrangements position liquid fuel module 150 with gas turbine system 90. Again, liquid fuel module 150 is within gas turbine system 90. The positioning of various pipes and valves of liquid fuel module 150 on floor 116 makes it very difficult to route pipes 130 of pipe array 122 to liquid fuel module 150, which hinders detection of any liquid fuel leaks. As noted previously, liquid fuel module 150 may include any now known or later developed system for portioning liquid fuel for the combustor of gas turbine system 90. As illustrated, liquid fuel module 150 may include various pipes and valves configured to portion liquid fuel.

FIGS. 3 and 4 show enlarged plan views of the area about liquid fuel module 150 in the upper right hand corner of FIG. 2. FIG. 3 shows liquid fuel leak detection system 200 with liquid fuel module 150, and FIG. 4 shows liquid fuel leak detection system 200 without liquid fuel module 150 (exposing tube array 158). As shown best in FIGS. 3 and 4, in this embodiment, liquid fuel leak detection system 200 may include a tube probe array 158 positioned adjacent floor 116 of gas turbine enclosure 110 under liquid fuel module 150. Tube probe array 158 includes at least one tube 160 having at least one opening 162 therein. Each tube 160 may be routed to areas under liquid fuel module 150 where detection is desired. Here, each tube 160 is in fluid communication with a hazardous gas sensor panel 170, including at least one hazardous gas sensor 172. Each tube 160 thus delivers air, e.g., a sample, from adjacent liquid fuel module 150 to a hazardous gas sensor panel 170 (described below). In FIGS. 3 and 4, two tubes 160 are shown, but any number can be employed. Each tube 160 includes its own opening(s) 162. Tubes 160 of liquid fuel leak detection system 200 have a smaller diameter than tube(s) 130 of turbine fuel leak detection and ventilation system 100 (FIG. 1), allowing tube(s) 160 to be relatively easily routed to desired areas under liquid fuel module 150. For example, pipes 130 may have an outer diameter of 2.5 centimeters (cm) to 10 cm, and tubes 160 may have a diameter of 0.5 cm to 2.2 cm. Further, tubes 160 may be made of flexible material, while pipes 130 are made of rigid material. Tubes 160 may not require mounts to hold their position. In any event, pipes 130 and tubes 160 are made of a material configured to withstand the environmental conditions of gas turbine enclosure 110, e.g., metal or metal alloys.

In this embodiment, each tube 160 delivers air, i.e., a sample, from adjacent liquid fuel module 150 to hazardous gas sensor panel 170. Hazardous gas sensor panel 170 detects an accumulation level of turbine liquid fuel vapors in gas turbine enclosure 110 from liquid fuel module 150 based on input from tube probe array 158. Hazardous gas sensor panel 170 may create an alarm in response to the detected first accumulation level exceeding a first predetermined amount. If sensor panel 124 detects a certain hazardous gas concentration level, for example, 5% of LEL, then the system will alarm. In addition thereto or alternatively, where system 200 is used with system 100, if the accumulation level reaches a higher level, for example 10% of LEL concentration, then the system(s) may active ventilation system 120 to remove the gas. A variety of alternative activation schemes may also be employed, e.g., just an alarm regardless of accumulation level exceeding a single predetermined amount, always at least some ventilation where paired with ventilation system 120, etc. In any event, a user is made aware of a liquid fuel leak in liquid fuel module 150, even though it is positioned with gas turbine system 90.

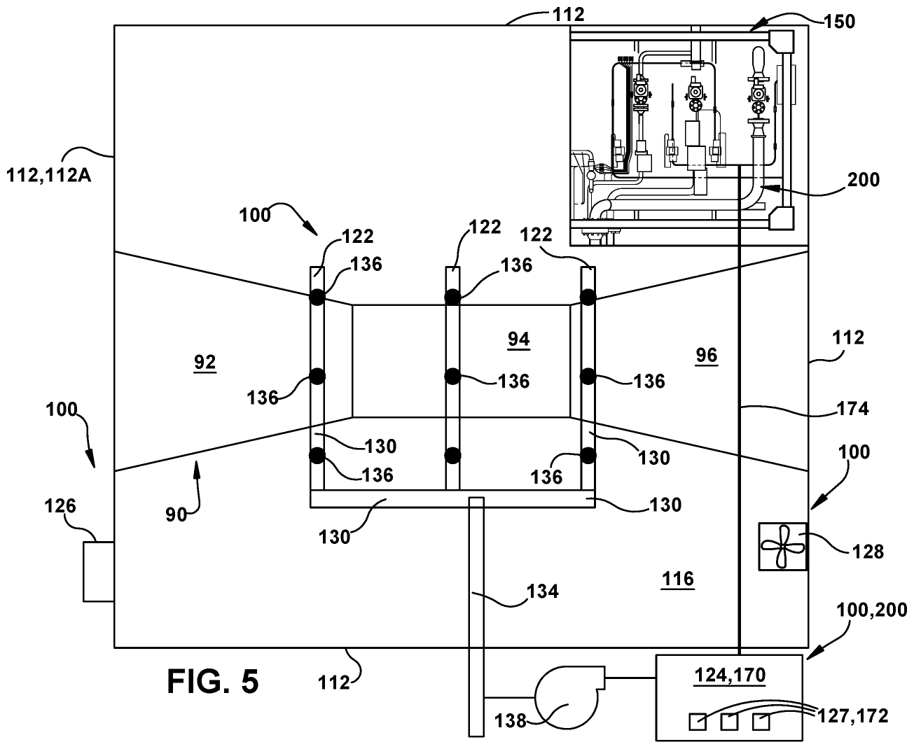

Referring to FIG. 5, in another embodiment, hazardous gas sensor panels 124, 170 may alternatively share at least one sensor 127, 172. Here, tube(s) 160 and/or pipe(s) 130 may be routed to a common sensor(s) 127, 172, i.e., a common hazardous gas sensor panel. In this manner, tube probe array 158 can also be retrofitted to work with a sensor panel 124 already in position within gas turbine enclosure 110, reducing the expense of having two sensor panels. As shown in FIGS. 3 and 4, hazardous gas sensor panel 170 may include a sensor 172 for each tube(s) 160, or tubes 160 may share a sensor 172, e.g., as shown in FIG. 5. In the latter case, tube probe array 158 may include one or a plurality of tubes 160 connected to a return pipe 174. Hazardous gas sensor panel 170 may positioned within gas turbine enclosure 110, and may be in close proximity to floor 116 of gas turbine enclosure 110, e.g., within 1 meter.

A method according to embodiments of the disclosure may include positioning tube probe array 158 or individual sensors 172 adjacent floor 116 of gas turbine enclosure 110 and under liquid fuel module 150. As noted, tube probe array 158 may include a plurality of tubes 160 with each of the tubes having a plurality of openings 162 therein. The method may further include detecting a first accumulation level of turbine liquid fuel vapors in gas turbine enclosure 110 based on input from tube probe array 158 or individual sensors 172. An alarm can be created in response to the detected first accumulation level exceeding a first predetermined amount, as noted. Alternatively, if paired with ventilation system 120, the latter may be activated to remove hazardous vapors, e.g., by the ventilation system directing an air flow sweep along floor 116 of gas turbine enclosure 110.

In an optional embodiment, the method can also include positioning pipe array 122 adjacent floor 116 of gas turbine enclosure 110 and under combustor fuel delivery system 98 on combustor 94, the pipe array including a plurality of pipes 130 with each of the pipes having a plurality of inlet openings 136 therein. A vacuum may be drawn on pipe array 122 to siphon an environmental sample from gas turbine enclosure 110 via the pipe array. An accumulation level of turbine fuel gas in gas turbine enclosure 110 can be detected, e.g., by sensor panel 124, based on input from the pipe array. Ventilation system 120 can be activated in response to the detected second accumulation level exceeding a predetermined amount, the ventilation system directing an air flow sweep along floor 116 of gas turbine enclosure 110. Gas turbine enclosure 110 configuration provides a sufficient velocity and velocity distribution in ventilation system 120 on gas turbine enclosure floor 116 so that any accumulation of heavier fuel gas can be expunged or ventilated out of the enclosure. The sampling pipes/tubes and the hazardous gas sensors are used to control an alarm and/or ventilation system 120 in the case of the detection of any significant amount of accumulation to ensure safe operation of the gas turbine. Similarly, liquid fuel leak detection system 200 may include tube probe array 158 or individual sensors 172 place near to floor 116 in liquid fuel module 150 to detect vapor leaks during unit running/shutdown scenario, eliminating any additional safety hazard associated with liquid fuel leaks in liquid fuel module 150 in its changed position.

Embodiments of the disclosure enable cost effective arrangement to detect liquid fuel leaks. The alternate solutions like routing additional piping 130 underneath liquid fuel module 150 requires additional space and creates additional maintenance concerns. The embodiment in which sensors are shared between panels 124 avoids the addition of sensors for detection of leaks in liquid fuel module 150 in its changed position, which saves money. Embodiments of the disclosure can be retrofitted to current gas turbine systems, or used with new installations.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A fuel leak detection system for a gas turbine enclosure for a gas turbine system, the gas turbine enclosure including a liquid fuel module therein, the fuel leak detection system comprising:
a liquid fuel module leak detection system including:
a sensor array positioned adjacent a floor of the gas turbine enclosure under the liquid fuel module, the sensor array including at least one hazardous gas sensor for detecting a first accumulation level of turbine liquid fuel vapors in the gas turbine enclosure from the liquid fuel module, and creating an alarm in response to the at least one hazardous gas sensor detecting the first accumulation level exceeding a first predetermined amount;
a fuel leak detection and ventilation system including:
a pipe array positioned adjacent the floor of the gas turbine enclosure and under a fuel delivery system for a combustor of the gas turbine system, the pipe array including at least one pipe having at least one opening therein;
a ventilation system including a fan and air flow outlet and an air flow inlet, wherein the fan directs an air flow sweep through the air flow inlet along the floor of the gas turbine enclosure; and
a first hazardous gas sensor panel in communication with the pipe array and the ventilation system, the first hazardous gas sensor panel detecting a second accumulation level of turbine fuel vapors in the gas turbine enclosure based on input from the pipe array, and activating the ventilation system in response to the detected second accumulation level exceeding a second predetermined amount.

2. A liquid fuel module leak detection system for a gas turbine enclosure including a liquid fuel module therein, the liquid fuel module leak detection system comprising:
a tube probe array positioned adjacent a floor of the gas turbine enclosure under the liquid fuel module, the tube probe array including at least one tube having at least one opening; and
a first hazardous gas sensor panel in communication with the tube probe array, the first hazardous gas sensor panel detecting a first accumulation level of turbine liquid fuel vapors in the gas turbine enclosure from the liquid fuel module based on input from the tube probe array, and creating an alarm in response to the detected first accumulation level exceeding a first predetermined amount.

3. The system of claim 2, wherein the first hazardous gas sensor panel is within the gas turbine enclosure.

4. The system of claim 2, wherein the sensor array is in close proximity to the floor of the gas turbine enclosure.

5. The system of claim 2, wherein the tube probe array comprises a plurality of tubes.

6. The system of claim 5, wherein the plurality of tubes each comprises a plurality of openings therein.

7. The system of claim 5, wherein the first hazardous gas sensor panel includes a sensor coupled to each of the plurality of tubes.

8. The system of claim 2, wherein each tube delivers air from adjacent the liquid fuel module to the first hazardous gas sensor panel.

9. The system of claim 2, further comprising a turbine fuel leak detection and ventilation system including:
a pipe array positioned adjacent the floor of the gas turbine enclosure and under a combustor fuel delivery system for a combustor of the gas turbine system, the pipe array including at least one pipe having at least one opening therein;
a ventilation system including a fan and an air flow outlet and an air flow inlet, wherein the fan directs an air flow sweep through the air flow inlet along the floor of the gas turbine enclosure; and
a second hazardous gas sensor panel in communication with the pipe array and the ventilation system, the second hazardous gas sensor panel detecting a second accumulation level of turbine fuel vapors in the gas turbine enclosure based on input from the pipe array, and activating the ventilation system in response to the detected accumulation level exceeding a second predetermined amount.

10. The system of claim 9, wherein the first hazardous gas sensor panel and the second hazardous gas sensor panel share at least one sensor.

11. The system of claim 9, wherein the pipe array comprises a plurality of pipes.

12. The system of claim 11, wherein the plurality of pipes each comprises a plurality of openings therein.

13. The system of claim 9, further comprising a suction device coupled with the pipe array, the suction device drawing a vacuum on the pipe array.

14. A fuel leak detection system for a gas turbine enclosure including a gas turbine system and a liquid fuel module therein, the fuel leak detection system comprising:
a pipe array positioned adjacent a floor of the gas turbine enclosure and under a combustor fuel delivery system for a combustor of the gas turbine system, the pipe array including at least one pipe having at least one opening therein;
a ventilation system including a fan and an air flow outlet and an air flow inlet, wherein the fan directs an air flow sweep through the air flow inlet along the floor of the gas turbine enclosure;
a tube probe array positioned adjacent the floor of the gas turbine enclosure under the liquid fuel module, the tube probe array including at least one tube having at least one opening; and
a hazardous gas sensor panel in communication with the pipe array and the tube probe array and the ventilation system, the hazardous gas sensor panel detecting a first accumulation level of liquid fuel vapors in the gas turbine enclosure and under the liquid fuel module based on input from the tube probe array and a second accumulation level of turbine fuel vapors in the gas turbine enclosure based on input from the pipe array, and creating an alarm according to at least one of the detected accumulation levels exceeding a respective predetermined level.

15. The system of claim 14, wherein the pipe array comprises a plurality of pipes.

16. The system of claim 15, wherein the plurality of pipes each comprises a plurality of openings therein.

17. The system of claim 14, further comprising a suction device coupled with the pipe array, the suction device drawing a vacuum on the pipe array.
